(19) United States
(12) Patent Application Publication
(10) Pub. No.: US 2026/0318454 A1
(43) Pub. Date: Oct. 15, 2026

(54) DEVICE FOR THE ACCURATELY FITTING SEALING OF AN OPENING, SURROUNDED BY A NON-FLAT SEALING FACE, OF AN APPARATUS

(71) Applicant: BASF SE, Ludwigshafen am Rhein (DE)

(72) Inventors: Felix HUELSMANN, Ludwigshafen am Rhein (DE); Christian KRAUSS, Ludwigshafen am Rhein (DE); Hans Martin ERKING, Ludwigshafen am Rhein (DE); David NIEMIEC, Ludwigshafen am Rhein (DE); Marvin KRAMP, Ludwigshafen am Rhein (DE); Cornelis Hendricus DE RUITER, Ludwigshafen am Rhein (DE); Bjoern STEIDEL, Ludwigshafen am Rhein (DE)

(21) Appl. No.: 19/100,967

(22) PCT Filed: Aug. 1, 2023
(86) PCT No.: PCT/EP2023/071240

§ 371 Date: Feb. 4, 2025

(30) Foreign Application Priority Data
Aug. 8, 2022 (EP) 22189235.9

(51) Int. Cl. F16L 23/22

(52) U.S. Cl. CPC F16L 23/22

(57) ABSTRACT

The invention relates to a device for the accurately fitting sealing of an opening (2), surrounded by a non-flat sealing face (3), of an apparatus (1), comprising an adapter (4) with a first end face (5) as a contact surface which has a first surface profile (6) that corresponds to the accurately fitting negative profile of the non-flat sealing face (3), and at least one flat seal (8) that is arranged between the non-flat sealing face (3) of the apparatus (1) and the first end face (5) of the adapter (4). Furthermore, the invention relates to a sealing system with such a device, use of such a device, a method for producing such a device and a method for producing an adapter (4) for such a device.

The invention relates to a device for the custom-fit sealing of an opening of an apparatus that is surrounded by a non-planar sealing face, comprising an adapter having a first end face as a contact face which has a first surface profile which corresponds to the custom-fit negative profile of the non-planar sealing face. The invention relates further to a device for the custom-fit sealing of an opening of an apparatus that is surrounded by a non-planar sealing face, comprising an adapter having a first end face as a contact face which has a first surface profile, wherein the first surface profile is irregular.

It is generally known that there are seals for an opening of an apparatus that is surrounded by a non-planar sealing face. Thus there are, for example, annular sealing elements which are generally manufactured as standard products by mass production. In general, the seal and flange dimensions of annular seals and flanges are the subject of corresponding standards. In general, flat seals are used as flange seal rings. An important criterion when using a flange seal ring or an associated flange is the surface pressure that acts on the sealing faces, which must be adjusted in a suitable manner in dependence on the sealing material.

If the surface pressure is too high, there is in principle the risk of the flange seal ring being damaged, wherein the sealing action is insufficient if the surface pressure is too low. Moreover, seals may also be exposed to harsh chemical conditions, so that the chemical resistance of the seal is also of great importance.

Document DE 10 2013 002 753 B3 discloses a method for producing a sealing element for sealing a connection of two flanges, at least one of which has a non-planar sealing face, wherein at a plurality of circumferential positions which lie in the circumferential direction of at least one flange and which lie in a direction perpendicular to the circumferential tangent, in particular one behind the other in a radial direction, a distance value between the sealing faces of the flange facing each other is determined and a single thickness value is determined from the multiple distance values of each circumferential position and a sealing element is produced in dependence on all thickness values, which depend on the circumferential position, which sealing element has a thickness that depends on the circumferential position, which thickness is constant at each of the circumferential positions corresponding to the flanges in a direction perpendicular to the circumferential tangent, in particular in the radial direction, and corresponds to the determined thickness value of the respective circumferential position.

A disadvantage of this implementation is that, if there are significant deviations of the distance value in the perpendicular direction to the circumferential tangent, leak-tightness can generally not be achieved, because account is taken of only one thickness value per circumferential position in the radial direction. Moreover, the sealing element can become worn or fatigued by physical or chemical stresses, whereby a new sealing element must be manufactured and mounted in a complicated operation.

Document DE 10 2011 056 835 B4 discloses a flange seal ring having an annular metallic base body and having sealing faces which are formed by portions of the base body, wherein the metallic base body is formed in at least three parts of an upper part, a lower part and an intermediate part and the intermediate part has at least one cavity into which a non-electrical pressure sensor is inserted, wherein the pressure sensor is arranged on both sides of the intermediate part so as to be covered by the upper part and by the lower part and is sealed with respect to an inner circumference of the flange seal ring. The pressure sensor here determines a local pressure within the flange seal ring, whereby the local surface pressure can be determined at the pressure sensor.

A disadvantage of this implementation is that, if there are significant deviations of the distance value in the radial and/or perpendicular direction to the circumferential tangent, leak-tightness cannot be achieved even if the surface pressure can optimally be adjusted by the pressure sensor.

The objects were, therefore, to provide a device for sealing a non-planar sealing face which, in the event of chemical decomposition, significant wear or material fatigue, can be replaced easily, quickly, inexpensively and without significant position deviation. A further object was to be able to provide the replacement parts that are generally required easily, quickly and inexpensively in the event of a repair to the device. An additional object was to provide a device for the reliable sealing of a non-planar sealing face, even if the distance values in the radial and/or perpendicular direction to the circumferential tangent of the non-planar sealing faces deviate significantly. Ensuring mechanical integrity is a fundamental requirement for reliable sealing.

These objects are achieved according to the present invention by a device for custom-fit sealing according to claim 1 or 2, by a sealing system according to claim 11, by the use of the device according to claim 17, by a method for producing the device or the sealing system according to claim 18, and by a method for producing an adapter suitable for the device according to claim 19. Advantageous embodiments of the device are given in claims 3 to 10 and advantageous embodiments of the sealing system are given in claims 12 to 16.

The device according to the invention for the custom-fit sealing of an opening of an apparatus that is surrounded by a non-planar sealing face comprises an adapter having a first end face as a contact face which has a first surface profile which corresponds to the custom-fit negative profile of the non-planar sealing face or is irregular, and at least one flat seal which is arranged between the non-planar sealing face of the apparatus and the first end face of the adapter.

This gives rise to the advantage that, because of the custom-fit negative profile or the irregular surface profile, excessive surface pressures which would result in physical damage to the flat seal are not achieved locally. The flat seal arranged between the adapter and the non-planar sealing face can thus be pressed over its entire surface with a homogeneous surface pressure suitable for the particular type of seal, so that a technically leak-tight sealing face can consequently be obtained. Moreover, the flat seal is readily available commercially because it does not require any special production for the non-planar sealing face.

The term “apparatus” is to be understood in this specification as being a general term for a technical device which is composed of a plurality of components and which performs specific functions. Thus, an “apparatus” may be, for example, a mixer, a column, a reactor or a heat exchanger.

The expression “non-planar sealing face” is understood in this specification as meaning an uneven, three-dimensional face which can be connected to a corresponding device or to a corresponding component such that technical leak-tightness is achieved and thus no or only a negligible mass flow of fluid is able to escape at the non-planar sealing face. A negligible mass flow of escaping fluid can here be understood as being the maximum mass flow that is permissible by the standard condition TA-Luft. The standard condition TA-Luft is given by the technical instructions on air quality control, the new version of which is accessible in the first general administrative regulation on the Federal Immission Control Act at the Federal Environment Agency: https://www.umweltbundesamt.de/(accessed on 4 Jun. 2022).

The apparatus preferably at least in part has a coating. Further preferably, the coating is an enamelled layer. The non-planar sealing face is formed in particular on the coating. The apparatus in particular has an enamelled layer, and further preferably the non-planar sealing face is formed on the enamelled layer. The non-planar sealing face is formed in particular, due to the production process, by the formation or application of the coating. The non-planar sealing face is thus in particular a surface of a coated, in particular of an enamelled, apparatus.

In this specification, the expression “opening of an apparatus” is understood as meaning, for example, a manhole of an apparatus or the opening of an apparatus that is surrounded by a flange.

The term “adapter” is to be understood in this specification as meaning a component which can be positioned on a sealing face provided with a flat seal in order to be able to achieve technical leak-tightness after the adapter has been pressed with the sealing face.

In this specification, the expression “surface profile” is understood as meaning, for example, the geometric surface of the non-planar sealing face to be sealed. The first surface profile is in particular irregular. Thus, the first surface profile has in particular elevations and depressions, wherein the elevations and depressions preferably deviate differently from a mean level of the first surface profile. Furthermore, adjacent elevations and/or depressions are preferably at different distances from one another. A difference between a maximum surface profile height and a minimum surface profile height is preferably less than 10 mm, further preferably less than 7 mm. The first surface profile is typically determined by the surface of the coating of the apparatus. Thus, the first surface profile is determined in particular by the formation or application of the coating of the apparatus.

The expression “negative profile” is understood in this specification as meaning a calculated surface profile which corresponds to the mirrored surface profile of the non-planar sealing face to be sealed. Thus, the heights in the negative profile correspond to the depths in the surface profile and vice versa. This calculated negative profile can be produced on an end face of an adapter by means of a machining tool, such as, for example, a CNC milling machine. After machining, the surface profile of that end face thus corresponds to the calculated negative profile, taking account of the measuring and manufacturing tolerances.

The expression “flat seal” is to be understood in this specification as meaning a seal which can be fitted, for example, in machine, apparatus and pipeline construction as a sealing element between two flanges of a component or of an apparatus. Typically, a flat seal is annular, preferably circular. The flat seal is acted upon primarily by pressure, temperature and the fluid to be sealed. In general, the chemical and physical stresses are to be taken into account.

The expression “contact face” is to be understood in this specification as meaning, for example, a surface or a support surface on which a flat seal, for example, can be placed.

The fitting accuracy of the custom-fit negative profile can be given, for example, by the determined integral F of the antiderivative f(r, phi): F=∫_{A}f(r,phi)dA, wherein dA is the surface element and the integration takes place over the end face A of the adapter. The antiderivative determines the values of the individual local gap heights which are formed between the non-planar sealing face and the end face of the adapter when the adapter is positioned on the non-planar sealing face, wherein the respective locations of the individual local gap heights are defined by the radial coordinate r and the circumferential coordinate phi. Within the antiderivative, the thickness of the flat seal is preferably subtracted from the individual local gap heights in order to calculate the fitting accuracy as though the adapter were positioned on the non-planar sealing face without the flat seal. By integration of the determined integral F over the end face A of the adapter, the value of the fitting accuracy can be calculated.

In a further example for calculating the value of the fitting accuracy, the value of the fitting accuracy is the maximum local gap height that occurs between the non-planar sealing face and the end face of the adapter when the adapter is positioned on the non-planar sealing face. The thickness of the flat seal can here preferably be subtracted from the maximum local gap height in order to calculate the value of the fitting accuracy as though the adapter were positioned on the non-planar sealing face without the flat seal.

The value of the fitting accuracy is characterized mainly by the manufacturing tolerances in the production of the adapter and/or by the measuring accuracy of the measurement of the non-planar sealing face of an apparatus and/or by the accuracy of the positioning of the adapter. The maximum permissible value for the fitting accuracy is specific to each application. The nature of the flat seals, the material of the flat seals, the size of the non-planar sealing face can influence the maximum permissible value for the fitting accuracy.

In a preferred embodiment, the adapter is manufactured from a metal or a metal alloy or from various metals or metal alloys. Preference is given to austenitic, superaustenitic or austenitic-ferritic stainless steels or nickel-based alloys.

This offers the advantage that the adapter has a greater hardness than the flat seal, and the surface profile of the custom-fit negative profile on the adapter is thus maintained even during sealing and the flat seal substantially only deforms. Moreover, the adapter has high strength, which permits high surface pressures and promises a longer service life. A long service life can additionally be achieved by using a material that is sufficiently corrosion-resistant, such as a metal or a metal alloy.

In a preferred embodiment, the flat seal comprises at least in part graphite or at least in part perfluoroalkoxy polymers (PFA). These materials are to be preferred in particular in the case of chemical processes because they have high chemical resistance to acid-containing substances, for example.

In a preferred embodiment, the device for custom-fit sealing is equipped with flat seals of graphite with a tanged stainless steel reinforcement or expanded metal inserts, or with flat seals of PFA. Suitable seals are thus used, which, in combination with the adapter, are able to hold up in use because the material of the flat seal has sufficient deformability to adapt to the surface profile of the adapter and to the surface profile of the non-planar sealing face.

In a preferred embodiment, the adapter comprises an outer lateral surface which adjoins the first end face with the formation of an angle and to which at least two positioning elements are fixed in a stationary manner. The positioning elements each have a guide rail which is designed such that, on positioning of the adapter on the first non-planar sealing face of the apparatus covered by the flat seal, the guide rail is guided by a protuberance on the apparatus, preferably by a locating screw on the apparatus, and the adapter thus reaches its predetermined position. This gives rise to the advantage that radial displacement or displacement in the circumferential direction is avoided on positioning. As a result, the adapter can be positioned as easily as possible in its intended position in relation to the non-planar sealing face, so that, in the particular application, custom-fit sealing of the opening of the apparatus that is surrounded by the non-planar sealing face is achieved in a simple manner.

In a preferred embodiment, the guide rail is modular so that it can be removed again after positioning. Thus, after positioning, clamping bracket screws, for example, can be used without problems for clamping the device to the non-planar sealing face of the apparatus.

In a preferred embodiment, the guide rail contains a locking bar, which preferably comprises a slot. A construction which is simple to implement and which also permits simple and sufficiently accurate positioning is thus made possible.

In a preferred embodiment, each positioning element is fixed in a stationary manner to the outer lateral surface of the adapter by means of at least one fastening element, preferably a screw, particularly preferably a locating screw, or the outer lateral surface of the adapter has a groove for each positioning element and the positioning element comprises at least one screw and a tongue, wherein the tongue fits into the groove of the outer lateral surface of the adapter, and the screw fixes the groove with the tongue in a stationary manner. Very precise fixing of the adapter to the non-planar sealing face is thus ensured. Preferably, the groove can be a polygonal groove, such as, for example, a triangular groove or a square groove.

In a preferred embodiment, the adapter is a cover, preferably a manhole or a blind cover.

In a preferred embodiment, the adapter has a second end face as a further contact face which is located on the opposite side to the first end face and has a second surface profile, wherein the second surface profile of the adapter corresponds to the custom-fit negative profile of a sealing face arranged on a component and surrounding an opening, and wherein the device contains at least one further flat seal which is arranged between the sealing face of the component and the second end face of the adapter. The second surface profile is in particular irregular. Thus, the second surface profile has in particular elevations and depressions, wherein the elevations and depressions preferably deviate differently from a mean level of the second surface profile. Furthermore, adjacent elevations and/or depressions are preferably at different distances from one another. A difference between a maximum surface profile height and a minimum surface profile height is preferably less than 10 mm, further preferably less than 7 mm.

The component preferably at least in part has a coating. Further preferably, the coating is an enamelled layer. The sealing face arranged on the component and surrounding an opening is in particular formed on the coating. The component has in particular an enamelled layer, and further preferably the sealing face arranged on the component and surrounding an opening is formed on the enamelled layer. The sealing face arranged on the component and surrounding an opening is formed in particular, due to the production process, by the formation or application of the coating. Thus, the sealing face arranged on the component and surrounding an opening is in particular a surface of a coated, in particular of an enamelled, component.

The second surface profile is typically determined by the surface of the coating of the component. Thus, the second surface profile is determined in particular by the formation or application of the coating of the component. Preferably, the first surface profile and/or the second surface profile is irregular.

In particular, the adapter has a second end face as a further contact face which is located on the opposite side to the first end face and has a second surface profile, wherein the second surface profile is irregular, and wherein the device contains at least one further flat seal which is arranged between the sealing face of the component and the second end face of the adapter.

These preferred embodiments permit two-sided sealing by an adapter which has on both of its end faces a respective negative profile of the non-planar sealing face. As a result, two pipes, for example, can be connected together.

In an alternative and preferred embodiment, two adapters for two components are used in order to be able to connect, for example, two pipes, two apparatus flanges or a pipe and an apparatus. In each case one adapter is used for one component, in order to seal the sealing face arranged on the respective component and surrounding an opening. An additional seal is then preferably inserted between the two adapters so that technical leak-tightness is ensured by way of both adapters while they are being used.

The invention further provides a sealing system comprising an apparatus and a device according to the invention.

In a first preferred embodiment, the sealing system comprises an apparatus, a component and a device according to the invention, wherein the component is preferably a pipe having a flange or a connection apparatus having a flange. By means of the device, the component can be attached to the apparatus in a fluid-tight manner.

In a further preferred embodiment, the sealing system comprises an apparatus, a component and a device according to the invention, wherein the apparatus has a flange, preferably an enamelled flange, the opening of which is surrounded by the non-planar sealing face.

The component is here preferably a pipe having a flange or a connection apparatus having a flange.

Flanges are typically present in an apparatus and are generally to be sealed as soon as operation is started. The non-planar sealing face of an enamelled flange can have particularly large deviations because the enamelled layer on the flange can have large thickness deviations and the flange, due to the production process, can have shape and position deviations in relation to the adapter. Shape and position deviations, the maximum surface profile height and/or the minimum surface profile height are in each case determined in particular in accordance with DIN 28007-2:2017-04.

The coating of the apparatus and/or of the component is preferably an oxide layer, in particular an enamelled layer. The coating, in particular the enamelled layer, preferably comprises oxides of silicon, boron, sodium, potassium, cobalt, nickel and/or aluminum and optionally oxides of titanium, zirconium and/or molybdenum. The coating, in particular the enamelled layer, further preferably comprises SiO₂, B₂O₃, Na₂O, K₂O and/or Al₂O₃.

In a further preferred embodiment, the sealing system comprises an apparatus and a device according to the invention, wherein the apparatus has a flange, preferably an enamelled flange, the opening of which is surrounded by the non-planar sealing face.

In a further preferred embodiment of the sealing system, the apparatus or the connection apparatus is an agitator vessel, a mixing apparatus, a column, a phase separator, a precipitator, a pipe or a reactor, preferably a chemical reactor or a chemical reaction column, particularly preferably a chemical reaction column for the preparation of acrylates.

The invention further provides the use of the device or of the sealing system according to one of the preceding, corresponding embodiments by the use in chemical processes, in particular in processes for the preparation of acrylates or in processes in which acrylates occur. In such uses, the device is to have increased chemical resistance with respect to the chemical substances in order to avoid chemical decomposition of the adapter and/or of one or both of the flat seals.

The invention further provides a method for producing a device according to the invention or a sealing system according to the invention, wherein the method comprises the following steps:
providing at least one opening of an apparatus that is surrounded by a non-planar sealing face, a flat seal and an adapter,
detecting the shape and position deviation of the at least one non-planar sealing face from a first end face of the adapter by a 3D scan, preferably a 3D laser scan,
reverse engineering the adapter as a CAD design based on the measured data of the 3D scan, wherein the negative profile of the at least one non-planar sealing face is prepared for the reverse engineering of the adapter and, in the case of two non-planar sealing faces as contact faces, a negative profile is prepared for both of the non-planar sealing faces,
producing a first surface profile on the first end face of the adapter by means of a machining tool, preferably by means of a CNC milling machine, particularly preferably a 5-axis CNC milling machine, wherein the data of the negative profile of the non-planar sealing face of the CAD design are transmitted to the machining tool by way of an interface, preferably a CAD/CAM interface, wherein, in the case of two non-planar sealing faces as contact faces, the first surface profile for the first end face of the adapter and a second surface profile for a second end face of the adapter are produced by means of the machining tool, wherein the data of the two negative profiles of the two non-planar sealing faces of the CAD design are transmitted to the machining tool by way of the interface, and
positioning the adapter on the non-planar sealing face, wherein the flat seal is arranged between the first end face of the adapter and the non-planar sealing face and, in the case of two non-planar sealing faces as contact faces, a flat seal is arranged in each case between the respective end face of the adapter and the corresponding non-planar sealing face.

The detection of the shape and position deviation of the non-planar sealing face from the first end face of the adapter by a 3D scan or by a 3D laser scan is very precise and can permit measuring tolerances, depending on the measuring device, in the double-digit or even in the single-digit micrometer range.

In a preferred embodiment of the method for producing a device according to the invention or a sealing system according to the invention, the detection of the shape and position deviation of the at least one non-planar sealing face from a first end face of the adapter by a 3D scan, preferably a 3D laser scan, is so implemented in detail that there are one or more protuberances on the apparatus which define a reference system for the shape and position deviation of the non-planar sealing face. The protuberances are preferably locating screws, wherein particularly preferably exactly two locating screws are fixedly mounted on the apparatus.

The adapter comprises an outer lateral surface which adjoins the first end face with the formation of an angle. A number of positioning elements corresponding to the number of protuberances on the apparatus are preferably fixed in a stationary manner to the outer lateral surface of the adapter, wherein the positioning elements each have a guide rail which is designed such that, on positioning of the adapter on the first non-planar sealing face of the apparatus covered by the flat seal, the respective guide rail is guided by a protuberance, preferably a locating screw, on the apparatus and the adapter thus reaches its predetermined position.

Taking account of the reference system and the positions of the positioning elements of the adapter, the shape and position deviation of the non-planar sealing face from the first end face of the adapter is determined by the 3D scan, wherein, during the measurement of the shape and position deviation by the 3D scan, the non-planar sealing face is preferably optically exposed.

Transfer of the measured data into CAD software allows the negative profile to be prepared quickly and without being susceptible to errors. The combination of the individual method steps allows a fully automated manufacturing process for the production of the device to be established.

The invention further provides a method for producing a sealing system according to the invention, wherein the method preferably comprises the following steps:
providing at least one opening of an apparatus surrounded by a non-planar sealing surface, a flat seal and an adapter,
detecting the shape and position deviation of the at least one non-planar sealing face from a first end face of the adapter by a 3D scan, preferably a 3D laser scan,
reverse engineering the adapter as a CAD design based on the measured data of the 3D scan, wherein the negative profile of the at least one non-planar sealing face is prepared for the reverse engineering of the adapter and, in the case of two non-planar sealing faces as contact faces, a negative profile is prepared for both of the non-planar sealing faces,
producing a first surface profile on the first end face of the adapter by means of a machining tool, preferably by means of a CNC milling machine, particularly preferably a 5-axis CNC milling machine, wherein the data of the negative profile of the non-planar sealing face of the CAD design are transmitted to the machining tool by way of an interface, preferably a CAD/CAM interface, wherein, in the case of two non-planar sealing faces as contact faces, the first surface profile for the first end face of the adapter and a second surface profile for a second end face of the adapter are produced by means of the machining tool, wherein the data of the two negative profiles of the two non-planar sealing faces of the CAD design are transmitted to the machining tool by way of the interface,
positioning the adapter on the non-planar sealing face, wherein the flat seal is arranged between the first end face of the adapter and the non-planar sealing face and, in the case of two non-planar sealing faces as contact faces, a flat seal is arranged in each case between the respective end face of the adapter and the corresponding non-planar sealing face, and
clamping the sealing system by means of at least one clamping element, preferably by means of a plurality of clamping bracket screws, wherein the clamping element clamps the non-planar sealing face of the apparatus to the adapter and, in the case of two non-planar sealing faces as contact faces, at least one clamping element clamps both non-planar sealing faces of the apparatus to the adapter.

Analogously to the method for producing the device, the combination of the individual method steps for producing the sealing system according to the invention permits a fully automated manufacturing process.

The invention further provides a method for producing an adapter for a device according to the invention or a sealing system according to the invention, wherein the method comprises the following steps:
providing at least one opening of an apparatus that is surrounded by a non-planar sealing face, and a blank for an adapter,
detecting the shape and position deviation of the at least one non-planar sealing face from a first end face of the blank by a 3D scan, preferably a 3D laser scan,
reverse engineering the adapter as a CAD design based on the measured data of the 3D scan, wherein the negative profile of the at least one non-planar sealing face is prepared for the reverse engineering of the adapter and, in the case of two non-planar sealing faces as contact faces, a negative profile is prepared for both of the non-planar sealing faces, and
producing a first surface profile on a first end face of the blank by means of a machining tool, preferably by means of a CNC milling machine, particularly preferably a 5-axis CNC milling machine, wherein the data of the negative profile of the non-planar sealing face of the CAD design are transmitted to the machining tool by way of an interface, preferably a CAD/CAM interface, and the blank is thereby machined to form the adapter, wherein, in the case of two non-planar sealing faces as contact faces, the first surface profile for the first end face of the blank and a second surface profile for a second end face of the blank are produced by means of the machining tool, wherein the data of the two negative profiles of the two non-planar sealing faces of the CAD design are transmitted to the machining tool by way of the interface and the blank is thereby machined to form the adapter.

Analogously to the method for producing the device or the sealing system, the combination of the individual method steps for producing an adapter for a device according to the invention or a sealing system according to the invention permits a fully automated manufacturing process.

The invention will be elucidated in detail hereinafter with reference to the drawings. The drawings should be considered to be schematic diagrams. They do not constitute a limitation of the invention, for example with regard to specific dimensions or design variants.

The figures show:

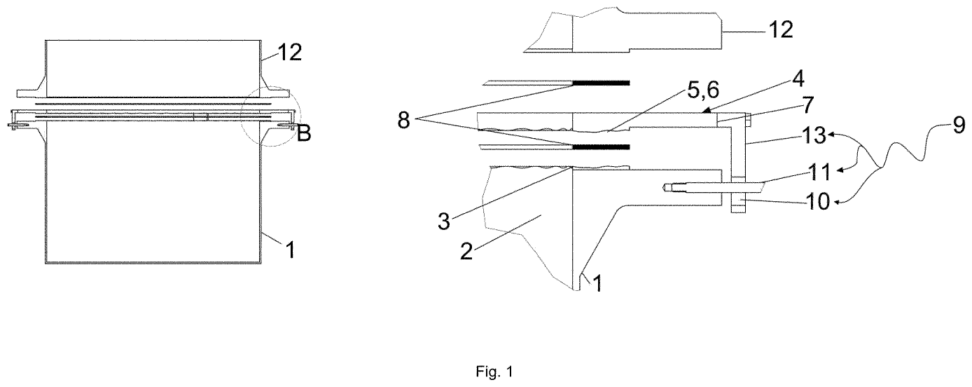

FIG. 1: A first embodiment of a sealing system according to the invention having an adapter and a component, wherein the adapter can be positioned on a non-planar sealing face of an apparatus.

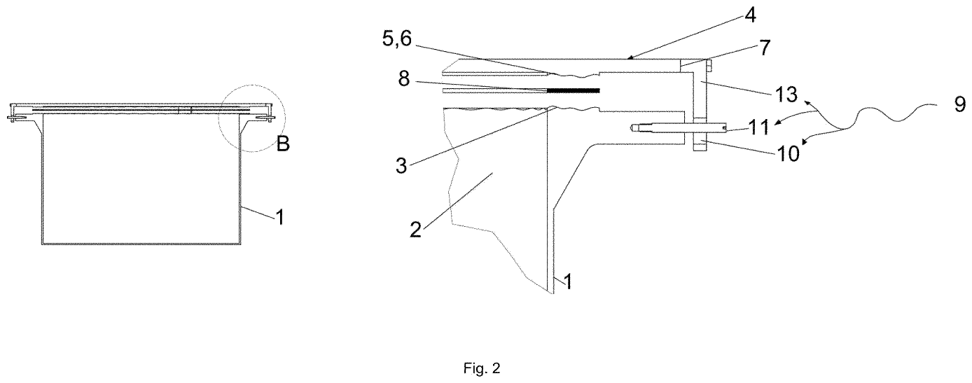

FIG. 2: A second embodiment of a sealing system according to the invention having an adapter in the form of a cover, wherein the adapter can be positioned on a non-planar sealing face of an apparatus.

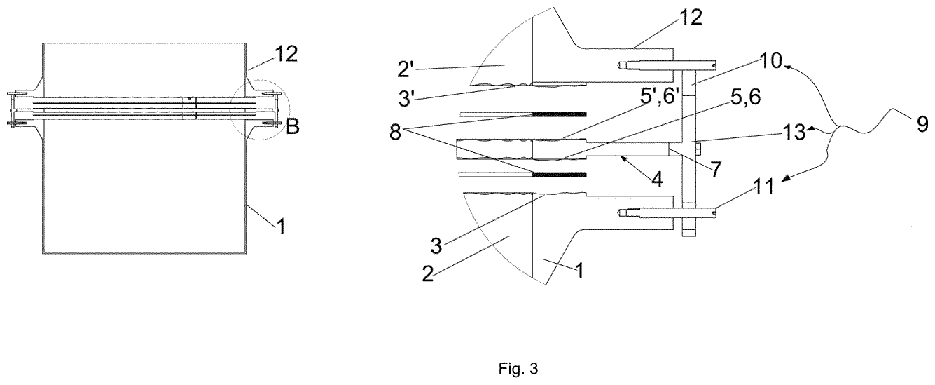

FIG. 3: A third embodiment of a sealing system according to the invention having a two-sided adapter, wherein the adapter has a first end face having a first surface profile and a second end face having a second surface profile and can be so positioned that it allows a component to be connected to an apparatus.

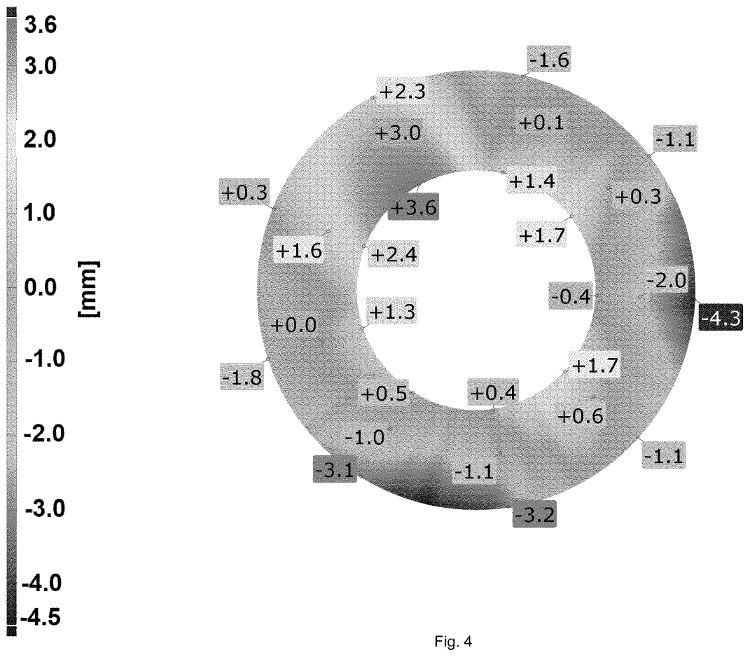

FIG. 4: The measured surface profile of the non-planar sealing face for the flange from example 1 in the form of a smoothed two-dimensional diagram.

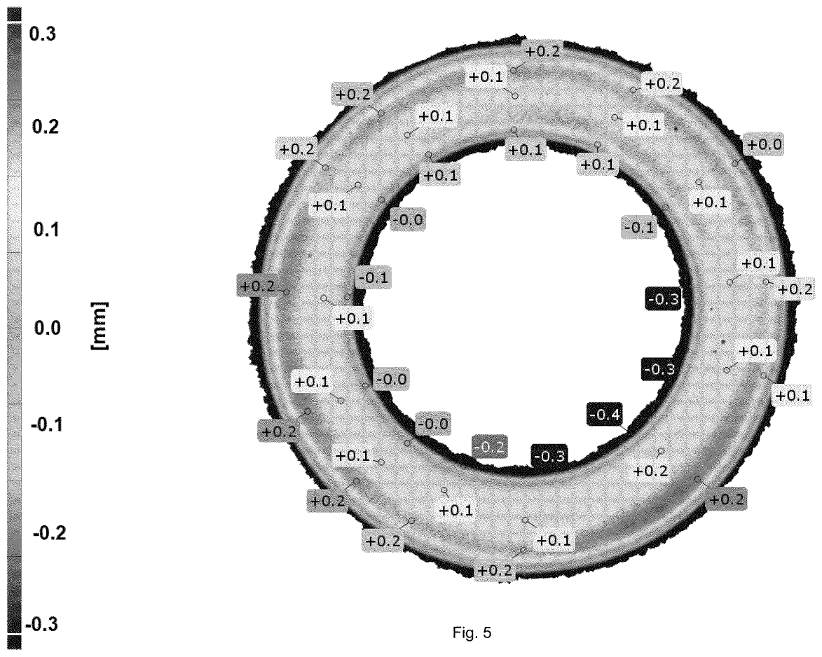

FIG. 5: The measured surface profile of the non-planar sealing face for the flange from example 2 in the form of a two-dimensional diagram.

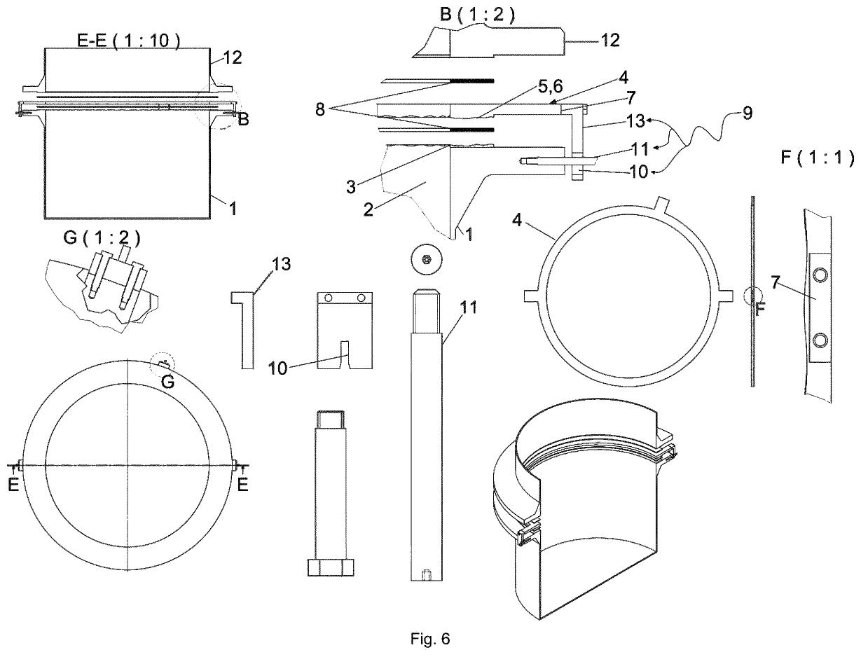

FIG. 6: Further details relating to the first embodiment of the sealing system according to the invention according to FIG. 1.

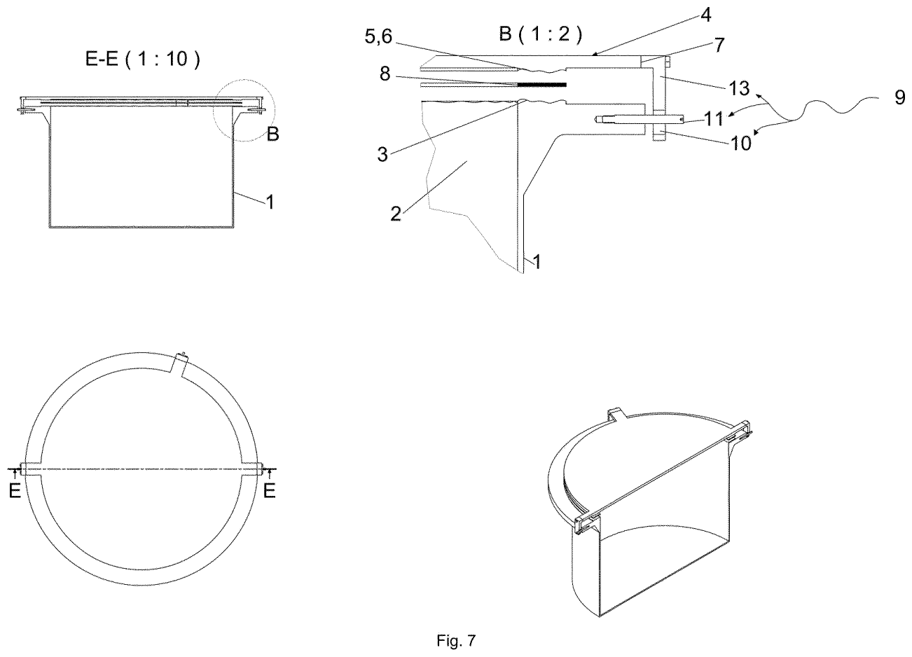

FIG. 7: Further details relating to the second embodiment of the sealing system according to the invention according to FIG. 2.

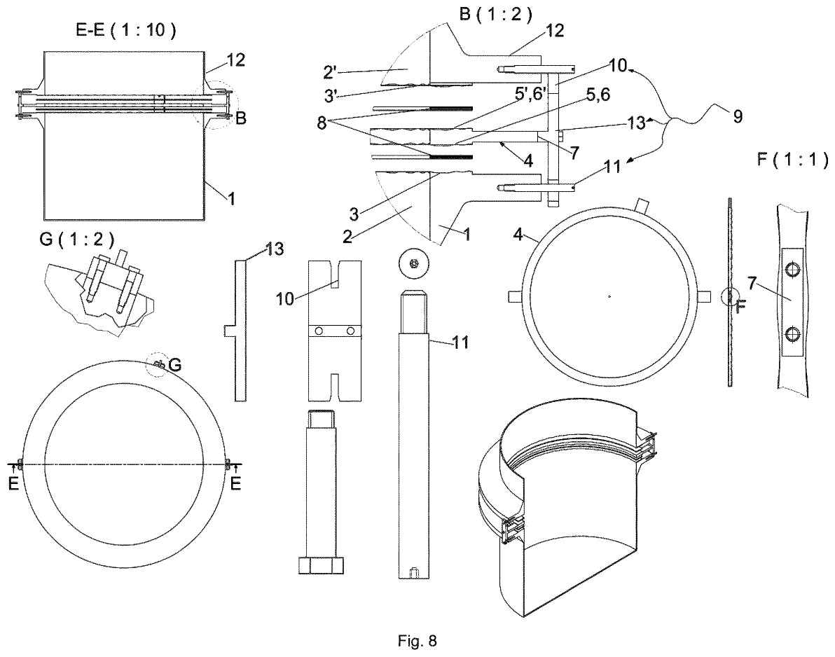

FIG. 8: Further details relating to the third embodiment of the sealing system according to the invention according to FIG. 3.

### LIST OF REFERENCE NUMBERS USED

1 apparatus
2 opening of an apparatus
2′ opening of a component
3 non-planar sealing face of an apparatus
3′ non-planar sealing face of a component
4 adapter
5 first end face
5′ second end face
6 first surface profile
6′ second surface profile
7 lateral surface
8 flat seal
9 positioning elements
10 guide rail
11 protuberance
12 component
13 locking bar

FIG. 1 shows a first embodiment of a sealing system according to the invention having an exemplary embodiment of a device according to the invention, an apparatus 1 and a component 12.

The left-hand side of FIG. 1 shows a section along the longitudinal axis of the sealing system, while the right-hand side of FIG. 1 shows a magnified region of the section in the vicinity of a positioning element 9, designated detail “B” in the image on the left. For the sake of clarity, the individual parts are shown spaced apart from one another in the unclamped state.

An adapter 4 is here positioned on a non-planar sealing face 3 of the apparatus 1 which is covered by a flat seal 8, wherein an opening 2 of the apparatus 1 is surrounded by the non-planar sealing face 3. Furthermore, on the opposite side of the adapter 4, a component 12 is positioned on the adapter 4 which is covered by a further flat seal 8. The adapter 4 is additionally equipped with a first end face 5 as a contact face which has a first surface profile 6 which corresponds to the custom-fit negative profile of the non-planar sealing face 3. The adapter 4 further has an outer lateral surface 7 which adjoins the first end face 5 with the formation of an angle, and two positioning elements 9 located opposite one another which are each fixed in a stationary manner to the outer lateral surface 7 of the adapter 4. The positioning elements 9 each have a guide rail 10 which is designed such that, on positioning of the adapter 4 on the first non-planar surface 3 of the apparatus 1 covered by the flat seal 8, the guide rail 10 is guided by a locating screw 11 on the apparatus 1 and the adapter 4 thus reaches its predetermined position. In this exemplary embodiment, the guide rail 10 contains a locking bar 13, which is provided with a slot.

FIG. 2 shows a second embodiment of a sealing system according to the invention having an exemplary embodiment of a device according to the invention and an apparatus 1.

The left-hand side of FIG. 2 shows a section along the longitudinal axis of the sealing system, while the right-hand side of FIG. 2 shows a magnified region of the section in the vicinity of a positioning element 9, designated detail “B” in the image on the left. For the sake of clarity, the individual parts are shown spaced apart from one another in the unclamped state.

An adapter 4 is here positioned on a non-planar sealing face 3 of the apparatus 1 which is covered by a flat seal 8, wherein an opening 2 of the apparatus 1 is surrounded by the non-planar sealing face 3. In this embodiment, the adapter 4 is a cover. The adapter 4 is additionally equipped with a first end face 5 as a contact face which has a first surface profile 6 which corresponds to the custom-fit negative profile of the non-planar sealing face 3. The adapter 4 further has an outer lateral surface 7 which adjoins the first end face 5 with the formation of an angle, and two positioning elements 9 located opposite one another which are each fixed in a stationary manner to the outer lateral surface 7 of the adapter 4. The positioning elements 9 each have a guide rail 10 which is designed such that, on positioning of the adapter 4 on the first non-planar surface 3 of the apparatus 1 covered by the flat seal 8, the guide rail 10 is guided by a locating screw 11 on the apparatus 1 and the adapter 4 thus reaches its predetermined position. In this exemplary embodiment, the guide rail 10 contains a locking bar 13, which is provided with a slot.

FIG. 3 shows a third embodiment of a sealing system according to the invention having an exemplary embodiment of a device according to the invention, an apparatus 1 and a component 12.

The left-hand side of FIG. 3 shows a section along the longitudinal axis of the sealing system, while the right-hand side of FIG. 3 shows a magnified region of the section in the vicinity of a positioning element 9, designated detail “B” in the image on the left. For the sake of clarity, the individual parts are shown spaced apart from one another in the unclamped state.

An adapter 4 is here positioned on a non-planar sealing face 3 of the apparatus 1 which is covered by a flat seal 8, wherein an opening 2 of the apparatus 1 is surrounded by the non-planar sealing face 3. Moreover, on the opposite side of the adapter 4, a component 12 is positioned on a non-planar sealing face 3′ covered by a flat seal 8, wherein the adapter 4 has a first and a second end face 5, 5′ having corresponding surface profiles 6, 6′ in order to allow the component 12 to be connected to the apparatus 1. The adapter 4 further has an outer lateral surface 7 which adjoins the first end face 5 with the formation of an angle, and two positioning elements 9 located opposite one another which are each fixed in a stationary manner to the outer lateral surface 7 of the adapter 4. The positioning elements 9 each have a guide rail 10 which is designed such that, on positioning of the adapter 4 on the first non-planar surface 3 of the apparatus 1 covered by the flat seal 8, the guide rail 10 is guided by a locating screw 11 on the apparatus 1 and the adapter 4 thus reaches its predetermined position. In this exemplary embodiment, the guide rail 10 contains a locking bar 13, which is provided with a slot.

FIG. 6 shows further details relating to the first embodiment of the sealing system according to the invention according to FIG. 1. In particular, the image at bottom left in FIG. 6 shows a top view of the adapter 4, while the image at bottom right in FIG. 6 shows a perspective sectional drawing of the sealing system according to FIG. 1. Moreover, the guide rail 10, locating screw 11, lateral surface 7 and locking bar 13 belonging to the sealing system are also shown in the bottom region of the figure.

FIG. 7 shows further details relating to the second embodiment of the sealing system according to the invention according to FIG. 2. In particular, the diagram at bottom left in FIG. 7 shows a top view of the adapter 4, whereas the diagram at bottom right in FIG. 7 shows a perspective sectional drawing of the sealing system according to FIG. 2. Moreover, the guide rail 10, locating screw 11, lateral surface 7 and locking bar 13 belonging to the sealing system are also shown in the bottom region of the figure.

FIG. 8 shows further details relating to the third embodiment of the sealing system according to the invention according to FIG. 3. In particular, the diagram at bottom left in FIG. 8 shows a top view of the adapter 4, whereas the diagram at bottom right in FIG. 8 shows a perspective sectional drawing of the sealing system according to FIG. 3. Moreover, the guide rail 10, locating screw 11, lateral surface 7 and locking bar 13 belonging to the sealing system are also shown in the bottom region of the figure.

### Example 1

### Component Test of the Sealing System

In this example 1, an embodiment according to the invention of the sealing system having a flange, a flat seal 8 and an adapter 4 was tested for mechanical integrity of the flat seals 8 used in each case after pressing. Both the adapter 4 and the flange were here manufactured from EN 1.4541 steel. The nominal width of the flange was DN50, wherein the flange had a non-planar sealing face 3.

The measured surface profile 6 of the non-planar sealing face 3 is shown in FIG. 4 in the form of a smoothed two-dimensional diagram, wherein the surface profile 6 of the non-planar sealing face 3 is represented in the shades of gray according to the scale on the left-hand side in FIG. 4. The individual numerical values shown on the surface profile 6 are measured in millimeters. As is apparent from FIG. 4, the maximum surface profile height is 3.6 mm and the minimum surface profile height is −4.3 mm. The maximum and minimum values are found increasingly at the edge regions of the surface profile 6 of the non-planar sealing face 3.

In the tests, various circular, annular flat seals 8 of nominal width DN 50 were tested in accordance with table 1. The inside diameter was 61 mm and the outside diameter was 107 mm.

The adapter 4 was positioned with the respective flat seal 8 on the non-planar sealing face 3 of the flange and then clamped. Clamping corresponded to a mounting tightening torque of 75 Nm provided for the nominal width DN 50. The coefficient of friction μ was 0.13.

TABLE 1
Flat seals for mechanical tests

| | | damaged/ |
|---|---|---|
| Type of seal | Material manufacturer | not damaged |
| Sigraflex | SGL | not damaged |
| Universal | (https://www.sglcarbon.com/:accessed | |
| Pro/3 mm | on Apr. 7, 2022) | |
| Novaphit | Frenzelit | not damaged |
| SSTC TaL/3 | (https://www.frenzelit.com/:accessed | |
| mm | on Apr. 7, 2022) | |
| PFA/3 mm | Simona | not damaged |
| | (https://www.simona.de/:accessed on | |
| | Apr. 7, 2022) | |

The tests have shown that the flat seals 8 with a graphite insert both of the Sigraflex Universal Pro type and of the Novaphit SSTC TaL type are able to adapt sufficiently to the unevenness of the non-planar sealing face 3 without being mechanically damaged. The same is true for the seal of the material PFA. The PFA was obtained from Simona, and the technical data sheet is available at the internet link http://products.simona.de/download/PFA_2022-06-29_14-03-50-891.pdf (accessed on 30 Jun. 2022).

Example 1 shows that the flat seals 8 are able to adapt sufficiently when the adapter 4 is pressed with the non-planar sealing face 3, and mechanical integrity can thus be ensured. Mechanical integrity is a fundamental requirement for reliable sealing.

### Example 2

### Performance of Leak-Tightness Tests

In this example 2, an embodiment according to the invention of the sealing system having an enamelled flange, a flat seal 8 and an adapter 4 was tested for technical leak-tightness of the sealing system after pressing. FIG. 2 corresponds to the sealing system of this example. The test apparatus here represents the apparatus 1, and the corresponding surface of the flange represents the non-planar sealing face 3 of the apparatus 1.

The adapter 4 was manufactured from EN 1.4541 steel. The nominal width of the enamelled flange was DN50, wherein the enamelled flange had a non-planar sealing face 3. During manufacture, the shape and position deviation of the non-planar sealing face 3 from the first end face 5 of the adapter 4 was first determined by a 3D laser scan. The measured data of the 3D scan were transferred into CAD software. A reverse engineering of the adapter 4 as a CAD design was then calculated, wherein the negative profile of the at least one non-planar sealing face 3 is prepared for the reverse engineering. The data of the CAD design were then transferred to a CNC milling machine by means of a CAD/CAM interface, whereby the CNC milling machine was able to produce the custom-fit negative profile of the non-planar sealing face 3 on the first end face 5 of the adapter 4.

The measured surface profile 6 of the non-planar sealing face 3 is shown in FIG. 5 in the form of a two-dimensional diagram, wherein the surface profile 6 of the non-planar sealing face 3 is represented in the shades of gray according to the scale on the left-hand side in FIG. 5. The individual numerical values shown on the surface profile 6 are measured in millimeters. As is apparent from FIG. 5, the maximum surface profile height is 0.2 mm and the minimum surface profile height is −0.4 mm. The maximum and minimum values are found increasingly at the edge regions of the surface profile 6 of the non-planar sealing face 3.

In the tests, various flat seals 8 were tested in accordance with table 2. In each case, a circular, annular flat seal 8 was used for a leak-tightness test in order to permit an assessment of whether all the method steps for producing a sealing system can be so implemented that sufficient technical leak-tightness can be achieved.

For the leak-tightness tests, a test device with a vacuum-tight hood was used, whereby the space around the flange was evacuated by a helium mass spectrometer. From the underside of the test device, helium was supplied at room temperature into the opening 2 of the flange as test medium. An excess pressure of 10 bar was established. The leakage rates were determined by a helium mass spectrometer. The measured leakage rates for the tested seals are shown in table 2.

TABLE 2
Test results/Leakage rates

| | | Leakage |
|---|---|---|
| | | rate in mg/ |
| Type of seal | Material manufacturer | (s · m) |
| Sigraflex | SGL | 1.9 · 10⁻³ |
| Universal | | |
| Pro/3 mm | | |
| PFA 3 mm | Simona | 6.0 · 10⁻⁶ |
| Gylon Style | Garlock | 1.0 · 10⁻³ |
| 3504E/3 mm | (https://legacy.garlock.com/de: | |
| | accessed on Apr. 7, 2022) | |

In comparison with the conventional PTFE seal Gylon Style 3504E, the measured leakage rates from table 2 show that, by using the tested flat seals 8 Sigraflex and PFA, a comparable level of leak-tightness is obtained. The permissible leakage rate for leakage class 0.01 under the standard condition TA-Luft corresponds to a leakage rate of 1*10⁻² mg/(s·m), wherein the standard condition TA-Luft is given by the technical instructions on air quality control, the new version of which is accessible in the first general administrative regulation on the Federal Immission Control Act at the Federal Environment Agency: https://www.umweltbundesamt.de/ (accessed on 4 Jun. 2022).

All the tests show a lower leakage rate than prescribed by the standard condition TA-Luft for technical leak-tightness. All the tests thus meet the criterion of technical leak-tightness.

Example 2 shows that reliable technical leak-tightness is achieved when a non-planar sealing face 3 is sealed by the indicated embodiments of the device according to the invention and of the sealing system according to the invention. An exemplary embodiment of the method for producing the device according to the invention has here been used and successfully implemented.

1.-19. (canceled)

20. A sealing system comprising an apparatus and a device for the custom-fit sealing of an opening of the apparatus that is surrounded by a non-planar sealing face, comprising an adapter having a first end face as a contact face which has a first surface profile which corresponds to the custom-fit negative profile of the non-planar sealing face, and at least one flat seal which is arranged between the non-planar sealing face of the apparatus and the first end face of the adapter, wherein the apparatus has a coating and the non-planar sealing face is formed on the coating.

21. The sealing system according to claim 20, wherein the adapter is manufactured from a metal or a metal alloy or from various metals or metal alloys.

22. The sealing system according to claim 20, wherein the flat seal contains at least in part graphite or at least in part perfluoroalkoxy polymers (PFA).

23. The sealing system according to claim 22, wherein the device is equipped with flat seals of graphite with a tanged stainless steel reinforcement or expanded metal inserts, or with flat seals of PFA.

24. The sealing system according to claim 20, wherein the adapter comprises an outer lateral surface which adjoins the first end face with the formation of an angle, at least two positioning elements are fixed in a stationary manner to the outer lateral surface of the adapter, and the positioning elements each have a guide rail which is designed such that, on positioning of the adapter on the first non-planar sealing face of the apparatus covered by the flat seal, the guide rail is guided by a protuberance on the apparatus, and the adapter thus reaches its predetermined position.

25. The sealing system according to claim 24, wherein each positioning element is fixed in a stationary manner to the outer lateral surface of the adapter by means of at least one fastening element, or the outer lateral surface of the adapter has a groove for each positioning element and the positioning element comprises at least one screw and a tongue, wherein the tongue fits into the groove of the outer lateral surface of the adapter, and the screw fixes the groove with the tongue in a stationary manner.

26. The sealing system according to claim 20, wherein the adapter is a cover.

27. The sealing system according to claim 20, wherein the adapter has a second end face as a further contact face which is located on the opposite side to the first end face and has a second surface profile, wherein the second surface profile of the adapter corresponds to the custom-fit negative profile of a sealing face arranged on a component and surrounding an opening, and wherein the device contains at least one further flat seal which is arranged between the sealing face of the component and the second end face of the adapter.

28. The sealing system according to claim 20, wherein the first surface profile or the second surface profile is irregular.

29. The sealing system according to claim 20, wherein the apparatus has an enamelled layer.

30. The sealing system according to claim 20, wherein the sealing system comprises a component, wherein the component is a pipe having a flange or a connection apparatus having a flange.

31. The sealing system according to claim 20, wherein the apparatus has a flange, the opening of which is surrounded by the non-planar sealing face.

32. The sealing system according to claim 20, wherein the apparatus or the connection apparatus is an agitator vessel, a mixing apparatus, a column, a phase separator, a precipitator, a pipe or a reactor.

33. The sealing system according to claim 20, wherein the sealing system is used in chemical processes.

34. A method for producing a sealing system according to claim 20, comprising the steps:
providing at least one opening of an apparatus that is surrounded by a non-planar sealing face, a flat seal and an adapter,
detecting the shape and position deviation of the at least one non-planar sealing face from a first end face of the adapter by a 3D scan,
engineering the adapter as a CAD design based on the measured data of the 3D scan, wherein the negative profile of the at least one non-planar sealing face is prepared for the reverse engineering of the adapter and, in the case of two non-planar sealing faces as contact faces, a negative profile is prepared for both of the non-planar sealing faces,
producing a first surface profile on the first end face of the adapter by means of a machining tool, wherein the data of the negative profile of the non-planar sealing face of the CAD design are transmitted to the machining tool by way of an interface, wherein, in the case of two non-planar sealing faces as contact faces, the first surface profile for the first end face of the adapter and a second surface profile for a second end face of the adapter are produced by means of the machining tool, wherein the data of the two negative profiles of the two non-planar sealing faces of the CAD design are transmitted to the machining tool by way of the interface, and
positioning the flat seal between the non-planar sealing face of the apparatus and the first end face of the adapter, wherein, in the case of two non-planar sealing faces as contact faces, a further flat seal is provided, wherein one of the two flat seals is arranged between the first non-planar sealing face and the first end face and the other flat seal is arranged between the second non-planar sealing face and the second end face.

35. A method for producing an adapter for a sealing system according to claim 20, comprising the steps:
providing at least one opening of an apparatus that is surrounded by a non-planar sealing face, and a blank for an adapter,
detecting the shape and position deviation of the at least one non-planar sealing face from a first end face of the blank by a 3D scan,
engineering the adapter as a CAD design based on the measured data of the 3D scan, wherein the negative profile of the at least one non-planar sealing face is prepared for the reverse engineering of the adapter and, in the case of two non-planar sealing faces as contact faces, a negative profile is prepared for both of the non-planar sealing faces, and
producing a first surface profile on a first end face of the blank by means of a machining tool, wherein the data of the negative profile of the non-planar sealing face of the CAD design are transmitted to the machining tool by way of an interface, and the blank is thereby machined to form the adapter, wherein, in the case of two non-planar sealing faces as contact faces, the first surface profile for the first end face of the blank and a second surface profile for a second end face of the blank are produced by means of the machining tool, wherein the data of the two negative profiles of the two non-planar sealing faces of the CAD design are transmitted to the machining tool by way of the interface and the blank is thereby machined to form the adapter.
